(19) United States
(12) Patent Application Publication
(10) Pub. No.: US 2021/0262679 A1
(43) Pub. Date: Aug. 26, 2021

(54) CONVECTION-ENHANCED CENTRAL AIR CONDITIONING SYSTEM

(71) Applicant: Home Research Co., Ltd., Tokai-shi (JP)

(72) Inventor: Munenori Hisayoshi, Tokai-shi (JP)

(73) Assignee: Home Research Co., Ltd., Tokai-shi (JP)

(21) Appl. No.: 17/183,760

(22) Filed: Feb. 24, 2021

(30) Foreign Application Priority Data
Feb. 26, 2020 (JP) 2020-030420
Jul. 6, 2020 (JP) 2020-116257

(51) Int. Cl. F24F 7/06; F24F 1/0007

(52) U.S. Cl. CPC F24F 7/06; F24F 1/00075

(57) ABSTRACT

Convection-enhanced thermal insulation and central air conditioning capable of maintaining a comfortable indoor environment at reduced energy consumption is provided. A siding system comprises a first duct and an air passageway. The first duct has a first end thereof disposed in an underfloor space of a building, and a second end thereof disposed either on a ceiling or in a ceiling space of the building. The air passageway sends air from the underfloor space of the building to the ceiling or the ceiling space.

### CROSS-REFERENCE TO RELATED APPLICATIONS

The present patent application claims priority to Japanese Application Nos. 2020-030420 and 2020-116257, filed Feb. 26, 2020 and Jul. 6, 2020, respectively, each of which is incorporated herein by reference in its entirety.

### BACKGROUND OF THE INVENTION

### Technical Field

The present disclosure relates to convection-enhanced central air conditioning system.

### Background Art

To accomplish a comfortable indoor environment in a building, Patent Literatures 1 and 2 disclose providing an internal ventilation layer between a wall structure material and moisture-permeable interior wall, through which indoor air is discharged to outside of the building. Specifically, Patent Literature 1 discloses an air conditioning system for an “air-insulation building,” as well as an air conditioning method and program therefor, wherein a thin ventilation layer encompassing the building is utilized to enable air from an underfloor space to circulate throughout the building. Further, Patent Literature 2 discloses a method for indoor environment control in a building including a ventilation thermal insulation structure wherein indoor humidity is maintained at a comfortable level through operation of a humidifier and a dehumidifier installed therein.

### LIST OF REFERENCES

### Patent Literature 1: Japanese Unexamined Patent Application Publication No. 2017-161208

### Patent Literature 2: Japanese Unexamined Patent Application Publication No. 2006-207126

### BRIEF SUMMARY

Patent Literature 1 describes a so-called air-insulation building capable of maintaining a comfortable indoor environment at low cost. One aspect of the present disclosure is directed to improving capabilities of the air-insulation building. The method described in Patent Literature 2 is not specifically directed to control of indoor temperature, and as such, fails to provide for a practical, effective solution to maintain a comfortable indoor environment consistently, in particular, during summer and winter times.

Additionally, electric appliances, such as air conditioning equipment, installed to maintain the room in a comfortable indoor condition often requires substantial energy consumption where the air conditioner is operated at high power. Also, conventional methods are insufficient in terms of efficient use of cold and warm air present in the underfloor space.

In view of the above, an object of the present disclosure is to provide convection-enhanced thermal insulation and central air conditioning, and in particular, a convection-enhanced thermal insulation and central air conditioning system that employs a siding system in an air-insulation building, capable of maintaining a comfortable indoor environment at reduced energy consumption, and to accomplish energy saving and improved air-based thermal insulation capability through efficient use of cold and warm air derived from the underfloor space.

Such and other objectives are accomplished by a convection-enhanced central air conditioning system for a building according to an embodiment of the present disclosure, which may comprise: a first duct that has a first end thereof open and disposed in an underfloor space of the building, and a second end thereof open and disposed either on a ceiling of a first floor or in a ceiling space of the building; a louver disposed on the ceiling of the first floor of the building; and a vent that opens to the underfloor space, wherein a lower edge of a first peripheral wall of the building is positioned lower and closer to a foundation of the building than the vent is, wherein a first ventilation channel is formed between the first peripheral wall and a second peripheral wall that is disposed inside of the first peripheral wall, and wherein the first ventilation channel has an opening at a lower end thereof.

In some embodiments, the first ventilation channel may have an opening at an upper end thereof; and a second ventilation channel may be provided in a roof of the building, the second ventilation channel communicating with the opening at the upper end of the first ventilation channel.

In some embodiments, the system may send air from the underfloor space of the building either to the ceiling of the first floor or into the ceiling space; the system may heat the air where necessary; and the system may be capable of sending the heated air to the first floor of the building via the louver.

A convection-enhanced central air conditioning system for a two-story building according to an embodiment of the present disclosure may comprise: an exterior wall including a first peripheral wall that constitutes an exposed, visible surface of the two-story building, and a second peripheral wall that defines a room within the two-story building; a first ventilation channel provided in a gap between the first peripheral wall and the second peripheral wall, the first ventilation channel having an opening at a lower end thereof; a ventilation fan that sends air to the first ventilation channel; and a vent disposed at a level higher than a lower edge of the first peripheral wall, the vent defining an air passageway through which air flowing downward along a section of the first ventilation channel located in a first floor of the two-story building enters an underfloor space of the two-story building.

In some embodiments, the system may further comprise a second ventilation channel provided in a roof of the building, the second ventilation channel communicating with an opening at an upper end of the first ventilation channel; and a ridge ventilation unit provided in a ridge of the building, the ridge ventilation unit communicating with the second ventilation channel.

In some embodiments, the system may further comprise a first duct that has a first end thereof disposed in the underfloor space, and a second end thereof disposed either on a ceiling or in a ceiling space of the building; and a first fan that directs air to flow from the first end of the first duct to the second end of the first duct.

In some embodiments, the vent may be positioned higher than the lower edge of the first peripheral wall by 100 mm or more and 200 mm or less.

In some embodiments, the first peripheral wall may be formed of siding material.

In some embodiments, the system may further comprise one or more layers of foundation spacer material provided in the vent; and a flashing on or between the one or more layers of foundation spacer material.

In some embodiments, the one or more layers of foundation spacer material may be provided in the vent consisting of a single layer of foundation spacer material; the flashing may have a perforated panel directed generally downward; and the flashing may be disposed either above or below the single layer of foundation spacer material.

Beneficial effects related to the aspects of the present disclosure include the ability to provide a comfortable indoor environment with a lower energy consumption than would otherwise be required, along with the ability to efficiently use cold and warm air derived from the underfloor space to accomplish further reduction in energy consumption as well as improvements in the air-based thermal insulation.

### BRIEF DESCRIPTION OF THE DRAWINGS

The invention is better understood by reading the following detailed description with reference to the accompanying drawing figures, in which like reference numerals refer to like elements throughout, and in which:

FIG. 1 schematically illustrates a two-story building according to a first embodiment of the present disclosure;

FIGS. 2A and 2B are graphs plotting temperatures during winter measured before and after, respectively, installation of an exterior wall in the building according to the first embodiment;

FIG. 3 schematically illustrates a single-story building according to a second embodiment of the present disclosure;

FIG. 4 is a flowchart describing air conditioning procedure according to the second embodiment;

FIG. 5 schematically illustrates a single-story building provided with a geothermal duct according to a third embodiment of the present disclosure;

FIG. 6A is a partial view of the building along with an enlarged view of a flashing element included therein according to a fourth embodiment of the present disclosure, and FIG. 6B is an enlarged, isometric view of the flashing element of FIG. 6A; and

FIG. 7A is a partial view of the building along with an enlarged view of a flashing element included therein according to a modification of the fourth embodiment of the present disclosure, and FIG. 7B is an enlarged, isometric view of the flashing element of FIG. 7A.

### DETAILED DESCRIPTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

Referring now to the drawings, in which corresponding parts are identified with the same reference numeral, a building provided with a convection-enhanced thermal insulation and central air conditioning system (hereinafter also referred to as a siding system for an air-insulation building or a siding system) 1 according to one embodiment is described.

### First Embodiment

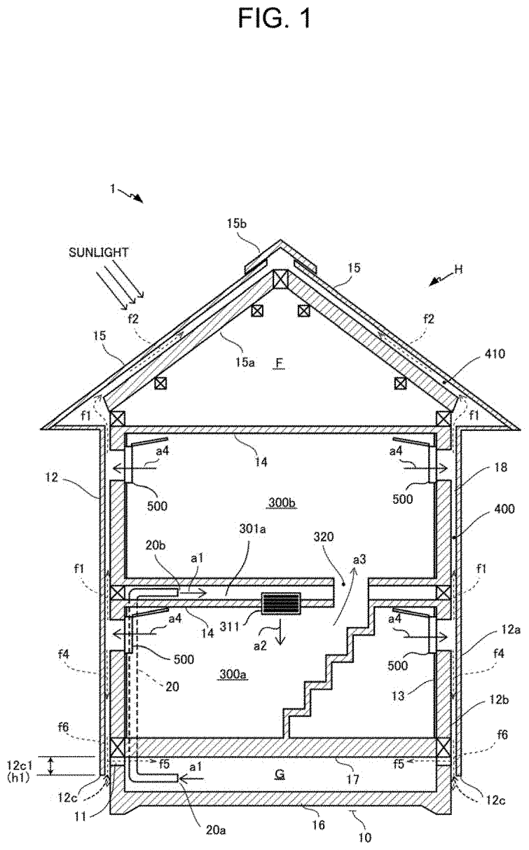

With reference to FIG. 1, a building H may, for example, comprise a two-story building (i.e., an architectural structure comprising a first floor and a second floor each containing one or more rooms) with wood framing. Specifically, the building H includes a base 10; an exterior wall 12 erected on the base 10; a ceiling space 301a provided between a first-floor room 300a (hereinafter referred to as “room 300a”) and a second-floor room 300b (hereinafter referred to as “room 300b”) each defined by an interior wall 13 and a ceiling board 14 as detailed below, with the respective ceiling boards 14 covering the ceilings of the rooms 300a and 300b; and a roof 15 disposed above the ceiling board 14 of the room 300b. The building H further includes a first duct 20. Although not depicted in the drawings, in some embodiments, the building H may comprise a three-story building, in which case the system may send air to one or more destinations as desired.

The base 10 is provided with a foundation 16 formed of concrete poured and hardened on the ground, and a vent 11 defining an air passageway to send air to an underfloor space G. Flooring 17 is provided above the base 10.

The exterior wall 12 may include a wood-textured board and insulation material, and is erected on the base 10. Specifically, the exterior wall 12 includes a first, outer peripheral wall 12a, generally referred to as “siding,” which constitutes an exposed, visible surface of the building H, and a second, inner peripheral wall 12b defining the room 300a and the 300b within the building H.

More specifically, the first peripheral wall 12a may include, for example, horizontal furring strips that extend in a horizontal direction; vertical furring strips attached to the horizontal furring strips and extending in a vertical direction perpendicular to the horizontal direction; and siding material attached to the vertical furring strips, in which case the horizontal furring strips may be attached to columns or the like via 3-mm thick spacers therebetween. The horizontal furring strips, the vertical furring strips, and the siding material are omitted from the drawings for brevity.

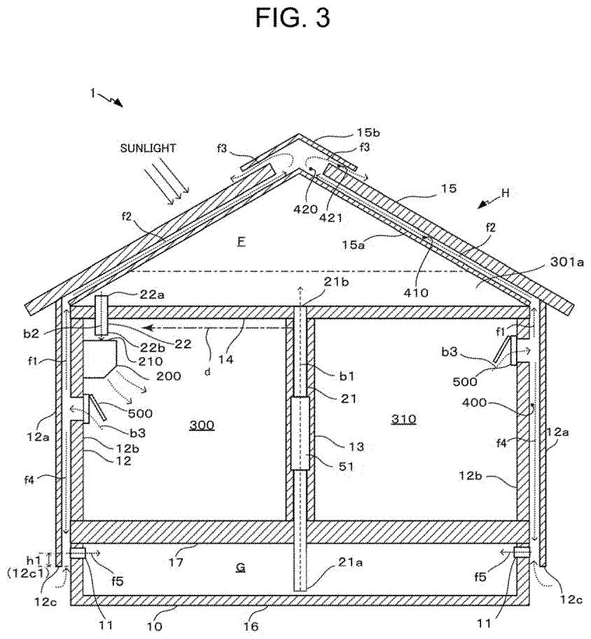

Between the first peripheral wall 12a and the second peripheral wall 12b is a gap in which a first ventilation channel 400 is formed to allow air passage therethrough. The first ventilation channel 400 may extend across both first and second floors in the second-story building H as depicted in FIG. 1, or across only the first floor in a single-story building H as depicted in FIG. 3. The first ventilation channel 400 has an opening at an upper end thereof communicated with a second ventilation channel 410 formed between the roof 15 and an inner lining 15a. A lower end of the first ventilation channel 400 is open.

A lower edge 12c of the first peripheral wall 12a extends downward to a level lower than the vent 11 by a height h1, such that the vent 11 is positioned higher than the lower edge 12c of the first peripheral wall 12a by the height h1. That is, the lower edge 12c of the first peripheral wall 12a is positioned below the vent 11 by an extra siding dimension 12c1 of the first peripheral wall 12a which is capable of serving siding purposes. The extra siding dimension 12c1, or height h1, may be equal to or greater than 100 mm and equal to or shorter than 200 mm, for example.

Air flowing through the first ventilation channel 400 may pass through the vent 11 to enter the underfloor space G. In addition to the air flow from the first ventilation channel 400, outside air flowing from beneath the lower edge 12c of the first peripheral wall 12a may also enter the underfloor space G through the vent 11. A pair of ventilation fans 500 may be provided, one in the room 300a and the other in the room 300b, to send air therefrom to the first ventilation channel 400.

The air layer formed within the first ventilation channel 400 may serve as a thermal insulation layer.

The interior wall 13 and the ceiling board 14 may be formed of wood-textured boards or the like. Various types of wall materials including boards may be used for enclosing and partitioning different areas in the building. In some embodiments, the interior wall 13 may separate one room 300a from another room 300b. Also, in some embodiments, the interior wall 13 may have a two-layered structure with an internal gap therethrough. The roof 15 includes a wood-textured board and a plurality of roof tiles arranged thereon, and is disposed above the ceiling board 14 of the room 300b. The ceiling board 14 of the room 300b and the roof 15 together define an attic F therebetween, whereas the ceiling board 14 of the room 300a defines the ceiling space 301a thereabove in the embodiment depicted in FIG. 1. The building H in the first embodiment includes the room 300a and the room 300b.

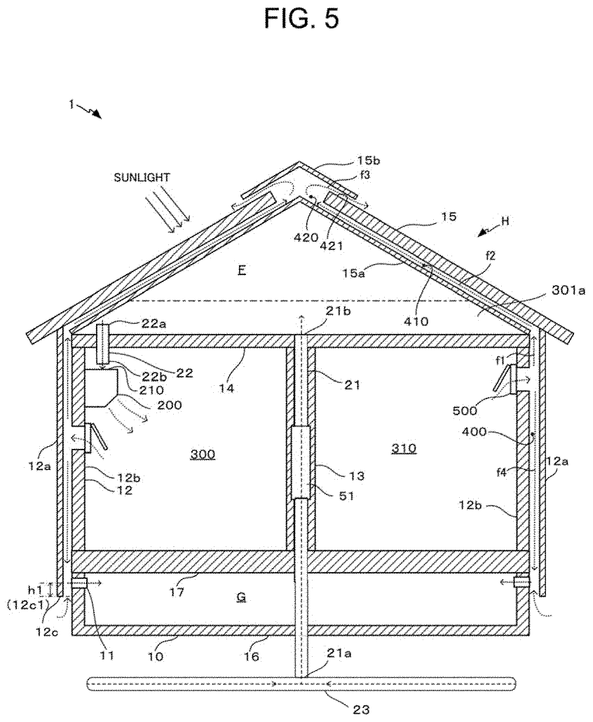

A ridge cover 15b is disposed atop the roof 15. The ridge cover 15b may be configured as a bent plate shaped to conform to the contour of the ridge. In some embodiments which are illustrated in FIGS. 3 and 5, for example, a gap 421 defining air passageway may also be provided between the ridge cover 15b and the roof 15 through which air flowing upward along the second ventilation channel 410 may be discharged to outside of the building H.

A louver 311 is provided in the embodiment depicted in FIG. 1. The louver 311 may be disposed on the ceiling of the room 300a, and/or in the ceiling space 301a or the like.

The first duct 20 may be provided, for example, inside the room 300a and may be covered with partitioning material or the like, not shown. A first, lower end 20a of the first duct 20 may be open and disposed in the underfloor space G of the building H. A second, upper end 20b of the first duct 20 may be open and disposed either on the ceiling of the room 300a or in the ceiling space 301a (e.g., a space called tenjo-bukuro in Japanese architecture). The first duct 20 serves to convey air, warm or cold, from the underfloor space G to the ceiling of the room 300a, inside of the room 300a, the ceiling space 301a, and/or the vicinity thereof. A duct fan, such as a cylindrical pipe fan or compact fan, for example, may be disposed is the first duct 20 to promote air flow from the lower end 20a to the upper end 20b of the duct 20.

Moreover, an opening 320 is provided in the ceiling or upper structure of the room 300a through which air may flow into the room 300b.

In the description of the present embodiment, identical parts and structures are designated by same terms and reference numerals where the two rooms 300a and 300b are configured similarly to each other.

With continued reference to FIG. 1, an air conditioning method performed with the siding system 1 according to the first embodiment is described.

The ceiling or the ceiling space 301a represents an area of the building H which tends to stay warmed by sunlight throughout a year. As such, the ceiling or the ceiling space 301a easily reaches a higher temperature during the daytime, compared to other interior spaces of the building H. That is, air in and around the ceiling or the ceiling space 301a stays relatively warm during the daytime. Also, air inside the underfloor space G, which is generally surrounded by the foundation 16, is supplied with heat from underground to remain at a relatively stable temperature irrespective of outside air temperature. That is, the underfloor space G tends to contain relatively warm air in winter, and relatively cold air in summer.

In operation, the siding system 1 causes air inside the underfloor space G to flow upward via the first duct 20 to the ceiling or the ceiling space 301a, as indicated by arrow a1. Alternatively, instead, air from the underfloor space G may be directed to the attic F via an air passageway, not shown. The air in the underfloor space G, which remains at a relatively high temperature during winter, for example, is thereby sent to the ceiling space 301a or the like. The air entering the ceiling space 301a is further heated with heat from the room 300b which is readily heated by sunlight, and subsequently flows into the room 300a via the louver 311 disposed on the ceiling of the room 300a, as indicated by arrow a2. The air entering the room 300a may subsequently enter the room 300b through the opening 320 provided in the ceiling or the like of the room 300a, as indicated by arrow a3.

Further, where the ventilation fans 500 in the rooms 300a and 300b are activated, air is directed to flow from the respective rooms 300a and 300b into the first ventilation channel 400, as indicated by arrows a4. The air entering the first ventilation channel 400 diverges into upward flow, as indicated by dotted arrows f1, and downward flow, as indicated by dotted arrows f4. The upward air flow f1 eventually reaches the opening at the upper end of the first ventilation channel 400 to subsequently enter the second ventilation channel 410, as indicated by dotted arrows f2. The downward air flow f4 may either pass through the vent 11 to enter the underfloor space G, as indicated by dotted arrows f5, or instead, be discharged to outside at the lower end of the first ventilation channel 400 which may be defined by the lower edge 12c of the first peripheral wall 12a, as indicated by dotted arrows f6. The siding system 1 according to the present embodiment thus enables the heated, warm air to circulate throughout the building H.

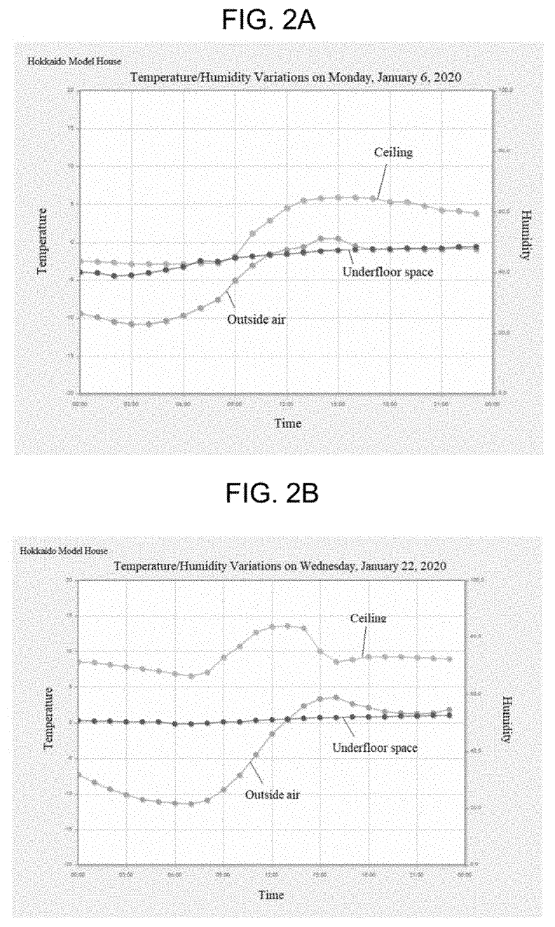

Possible beneficial effects derived from an example of the siding system 1 during winter are depicted with reference to FIGS. 2A and 2B, which are graphs plotting temperatures of the outside air as well as the ceiling and the underfloor space in the building H measured before and after, respectively, installation of an exterior wall incorporating thermal insulation according to the present disclosure.

As seen in FIG. 2A, the building H before installation of the exterior wall exhibits the ceiling temperature varying substantially in proportion to variations in the outside air temperature. That is, the lower the outside air temperature, the lower the ceiling temperature, and the higher the outside air temperature, the higher the ceiling temperature. The outside air temperature and the ceiling temperature both fluctuate throughout the day while staying within relatively low levels, wherein the outside air temperature varies from approximately −11° C. to approximately 1° C., and the ceiling temperature varies from approximately −3° C. to approximately 6° C. The temperature in the underfloor space G exhibits a relatively small amount of fluctuations and remains substantially constant within a low temperature range between −5° C. and 0° C.

By contrast, as seen in FIG. 2B, the building H after installation of the exterior wall exhibits the ceiling temperature remaining within a relatively high temperature range irrespective of variations in the outside air temperature. Specifically, the outside air temperature fluctuates in a range from approximately −12° C. to approximately 3° C. which is similar to that of the pre-installation measurements shown in FIG. 2A, whereas variations in the ceiling temperature occur within a relatively high temperature range from approximately 7° C. to approximately 14° C. The temperature in the underfloor space G remains within a range between 0° C. and 1° C., which is relatively high and stable compared to the pre-installation measurement shown in FIG. 2A.

The results observed in the post-installation building H may be attributed to the thermal insulation capability of the siding system 1, wherein provision of the ventilation channels allows warm air, which is heated initially in the underfloor space G from a geothermal heat source, followed by further heating via the ceiling or the ceiling space 301a, to circulate throughout the building H, thereby functioning as a thermal insulation layer that isolates the building H from ambient temperature changes to prevent the indoor temperature of the building H from being lowered during winter.

The above-described thermal insulation capability and resultant beneficial effects thereof are incorporated in the siding system 1 according to the present disclosure.

Specifically, for example, during winter where the temperature at the ceiling or the ceiling space 301a is higher than that of the underfloor space G, the siding system 1 causes air in the underfloor space G, which remains at a relatively constant temperature regardless of outside air, to flow to the ceiling or the ceiling space 301a via the first duct 20. The air from the underfloor space G reaching the ceiling or the ceiling space 301a is then heated to a temperature similar to that of the ceiling or the ceiling space 301a, or the temperature in the partitioning layer or the room 300b depending on a particular configuration. The warm air thus created is forwarded to the room 300a via the louver 311, and then to the room 300b through the opening 320. Although not depicted FIG. 1, the room 300a may be equipped with an air conditioner, for example, for efficient heating of the rooms 300a and 300b with reduced energy consumption, since the incoming air has already been heated to a relatively high temperature upon entering the air conditioner for further heating to a desired temperature.

During summer, by contrast, the siding system 1 causes air in the underfloor space G, which remains at a relatively constant, cold temperature regardless of outside air, to flow to the ceiling or the ceiling space 301a via the first duct 20, thereby preventing temperature from rising at the ceiling or the ceiling space 301a. Meanwhile, air surrounding the ceiling or the ceiling space 301a, which has been cooled by being mixed with the cold air from the underfloor space G, flows into the room 300a via the louver 311, and then to the room 300b through the opening 320. Although not depicted in FIG. 1, the room 300a may be equipped with an air conditioner, for example, for efficient cooling of the rooms 300a and 300b with reduced energy consumption, since the incoming air has already been cooled to a relatively low temperature upon entering the air conditioner for further cooling to a desired temperature.

For applications in cold regions where the temperature at the ceiling or the ceiling space 301a is lower than the temperature in the underfloor space G, air in the underfloor space G, which remains at a relatively constant, warm temperature regardless of outside air, is sent to the ceiling or the ceiling space 301a, and occasionally to further areas such as the room 300a, thereby raising the temperature at the ceiling or the ceiling space 301a and other downstream areas. The heated air may be sent to the room 300a via the louvre 311, and then to the room 300b through the opening 320. Although not depicted in FIG. 1, the room 300a may be equipped with an air conditioner, for example, for efficient heating of the rooms 300a and 300b with reduced energy consumption, since the incoming air has already been heated to a relatively high temperature upon entering the air conditioner for further heating to a desired temperature.

Hence, in cold region applications, the capability to adjust indoor temperature using air in the room 300a or the like which contains warm air from the underfloor space G as well as air surrounding the ceiling or the ceiling space 301a heated by sunlight and air conditioner allows for a comfortable indoor environment with reduced energy consumption during winter, compared to where, for example, indoor temperature control is performed solely by an air conditioning appliance.

Further, the capability of the siding system 1 to circulate, or cause convection of air throughout the building H not only allows for efficient indoor temperature control, but also enables discharge of odors and smoke to the outside, leading to a further pleasant indoor environment.

Furthermore, using the convection-enhanced thermal insulation and central air conditioning incorporated in the siding system 1 reduces the need for frequent opening of windows for ventilation, which can contribute to improved security as well as further reduction in energy consumption in the building.

Moreover, constant air flow through the first ventilation channel 400 and the second ventilation channel 410 enables the exterior wall 12 and the roof 15 to function as a thermal insulation layer which effectively shields the building H from thermal interference from the outside.

Additionally, positioning the vent 11 higher than the lower edge 12c of the first peripheral wall 12a by the height h1, that is, provision of the extra siding dimension 12c1, restricts inflow of air from the outside, which ensures that warm air constantly circulates across the underfloor space G and the first ventilation channel 400.

### Second Embodiment

Referring now to FIG. 3, a building H according to a second embodiment of the present disclosure is shown comprising s a single-story building. The building H includes a pair of rooms 300 and 310, and an interior wall 13 separating the rooms 300 and 310 from each other. The interior wall 13 has a two-layered structure with an internal gap therethrough. The room 300 is equipped with an air conditioner 200. Additional structures, such as a first duct 21, a second duct 22, a first fan 51, and the like, are also provided to circulate air throughout the building H.

Specifically, the first duct 21 is provided in the internal gap inside the interior wall 13. A first, lower end 21a of the first duct 21 is disposed in the underfloor space G of the building H. A second, upper end 21b of the first duct 21 is disposed in the ceiling space 301a in the attic F of the building H. The first duct 21 serves to send air from the underfloor space G to the ceiling space 301a. The first duct 21 is provided with the first fan 51 which serves to direct air to flow from the lower end 21a to the upper end 21b of the duct 21. The first fan 51 may be configured as a cylindrical pipe fan, for example. The first fan 51 is activated only where the air conditioner 200 is operating.

The second duct 22 penetrates through the ceiling board 14. The second duct 22 has a first, upper end 22a thereof disposed in the ceiling space 301a, and a second, lower end 22b thereof disposed adjacent to an air inlet 210 of the indoor unit of the air conditioner 200 provided in the room 300 of the building H. The second duct 22 serves to direct air, which have been forwarded from the underfloor space G and/or the ceiling space 301a, into the air inlet 210 of the indoor unit of the air conditioner 200.

With continued reference to FIG. 3, an air conditioning method performed with the siding system 1 according to the second embodiment is described.

In operation, the siding system 1 causes air inside the underfloor space G to flow upward via the first duct 21 to the ceiling space 301a, as indicated by dotted arrow b1, with the first fan 51 assisting the upward air flow. The air in the underfloor space G, which remains at a relatively high temperature during winter, for example, is thereby sent to the ceiling space 301a. The air entering the ceiling space 301a is further heated by sunlight, and thereafter is drawn into the air inlet 210 of the indoor unit of the air conditioner 200 via the second duct 22, as indicated by dotted arrow b2.

Further, where the ventilation fans 500 provided in the rooms 300 and 310 are activated, air is driven to flow from the respective rooms 300 and 310 to the first ventilation channel 400, as indicated by arrows b3. The air entering the first ventilation channel 400 diverges into upward flow, as indicated by dotted arrows f1, and downward air flow, as indicated by dotted arrows f4. The upward air flow f1 eventually reaches the opening at the upper end of the first ventilation channel 400 to subsequently enter the second ventilation channel 410, as indicated by dotted arrows f2, followed by being discharged through a ridge ventilation unit 420, as indicated by dotted arrows f3. The downward air flow f4 may either be discharged to outside at the lower end of the first ventilation channel 400, or instead pass through the vent 11 to enter the underfloor space G, as indicated by dotted arrows f5.

Additionally, a branch duct may be provided extending from the first duct 21 adjacent to the ceiling, which serves to send air from the underfloor space G of the building H directly into the room 300, such that the incoming air flows closely along the ceiling of the room 300, as indicated by broken arrow d. Provision of the branch duct allows for higher efficiency in air conditioning during summer wherein the room 300 is cooled with the relatively cold air derived from the underfloor space G. As described earlier, the siding system 1 according to the present embodiment may cause air which has been sent to the ceiling or the like from the underfloor space G to further flow to other parts of the building H, such as the room 300. Other features as to the building H may be similar to those depicted in the first embodiment.

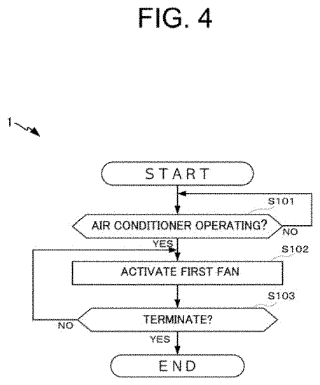

Referring now to FIG. 4, a flowchart describing an air conditioning control procedure performed by the siding system 1 according to the present embodiment is described.

Specifically, upon initiation of the air conditioning control procedure, a fan controller, not shown, determines whether or not the air conditioner 200 is operating (step S101). If the fan controller determines that the air conditioner 200 is not operating (“NO” in step S101), the fan controller activates the air conditioner 200, and repeats the determination step S101.

If the fan controller determines that the air conditioner 200 is operating (“YES” in step S101), the fan controller activates the first fan 51 (step S102). Once activated, the first fan 51 sends air from the underfloor space G toward the ceiling or the like, as indicated by dotted arrow b1 in FIG. 3. The air entering the ceiling space 301a may be further heated by sunlight. The air inside the ceiling space 301a or the like is further directed to the air inlet 210 of the indoor unit of the air conditioner 200 via the second duct 22, as indicated by dotted arrow b2 in FIG. 3.

Thereafter, the fan controller determines whether or not to terminate the air conditioning control procedure (step S103). Specifically, the determination to terminate the air conditioning control procedure is dependent on whether or not the air conditioner 200 is operating. If the fan controller determines not to terminate the air conditioning control procedure (“NO” in step S103), the activation step S102 is resumed and the fan controller allows the first fan 51 to continue operation.

If the fan controller determines that the air conditioner 200 has stopped operation, so that the air conditioning control procedure should be terminated (“YES” in step S103), the fan controller deactivates the first fan 51, thereby terminating the air conditioning control procedure.

Where the temperature at the ceiling or the ceiling space 301a is equal to or higher than a predetermined threshold (for example, 15° C.), the siding system 1 may send air from the underfloor space G to the ceiling or the like. As the incoming air is heated at the ceiling space 301a, the siding system 1 sends the warm air from the ceiling space 301a into the air inlet 210 of the indoor unit of the air conditioner 200 via the second duct 22.

Since the air has already been heated by sunlight upon entering the air inlet 210, heating the room 300 with the air conditioner 200 requires lower energy consumption than would otherwise be the case. Further, the ability to send air from the underfloor space G to the ceiling space 301a enables effective circulation of warm air throughout the building H, while preventing the temperature from lowering in the ceiling space 301a. For example, heating may be performed at a relatively low energy where the incoming air is heated by sunlight to approximately 20° C. in the ceiling space 301a, so that the air conditioner 200 is only required to raise the temperature by 4° C. to a typical set temperature of 24° C.

Moreover, where the temperature at the ceiling or the ceiling space 301a is less than a predetermined threshold (for example, 15° C.), the siding system 1 may send air from the underfloor space G directly into the rooms 300 and 310 via the aforementioned branch duct extending from an upper portion of the first duct 21. Since the incoming air is relatively warm upon entering the air inlet 210, heating the rooms 300 and 310 with the air conditioner 200 requires lower energy consumption than would otherwise be the case.

Accordingly, since the siding system 1 is capable of adjusting indoor temperature throughout the building H using warm air derived from the underfloor space G as well as air surrounding the ceiling or the ceiling space 301a, a comfortable indoor environment is accomplished with reduced energy consumption, compared to where, for example, indoor temperature control is performed solely by an air conditioning appliance. Also, a further reduction in energy consumption is accomplished by activating the first fan 51 only where the air conditioner 200 is operating.

Further, the capability of the siding system 1 to circulate, or cause convection of air throughout the building H not only allows for efficient indoor temperature control, but also enables discharge of odors and smoke to the outside, leading to a further pleasant indoor environment.

Furthermore, using the siding system 1 reduces the need for frequent opening of windows for ventilation, which can contribute to improved security as well as further reduction in energy consumption in the building.

Although the above description is provided mainly regarding an application of the siding system 1 for heating the building in cold regions during winter, a similar pattern of air flow may result from the operation of the siding system 1 for cooling application during summer. For example, during summer where the temperature at the ceiling or the ceiling space 301a is higher than the temperature of the underfloor space G, the siding system 1 sends air from the underfloor space G, which remains at a relatively constant temperature irrespective of outside air temperature, to the ceiling or the ceiling space 301a via the first duct 21. The air reaching the ceiling or the ceiling space 301a may be forwarded through the second duct 22 to be utilized, for example, to cool the room 300 or the like.

Although not illustrated in the drawings, in some embodiments, the second, upper end 21b of the first duct 21, which serves to convey the air from the underfloor space G to the ceiling or the ceiling space 301a, may be extended to the vicinity of the first, upper end 22a of the second duct 22.

### Third Embodiment

FIG. 5 describes the siding system 1 according to a third embodiment of the present disclosure. In the third embodiment, the building H may be either configured as a single-story building as depicted in FIG. 5, or alternatively, instead, a two or more story building as with the aforementioned first embodiment, wherein the building H is provided with one or more additional floors. A geothermal duct 23 is disposed underground to utilize heat exchange with the geothermal heat for cooling and heating the air flowing through the underfloor space G, thereby accomplishing increased thermal efficiency.

More specifically, in the present embodiment, the first duct 21 extending through the underfloor space G is provided with an air inlet, not shown, to connect with the third duct 23, such that the air flowing through the first duct 21 is diverted into the third duct 23 for recirculation into the first duct 21.

### Fourth Embodiment

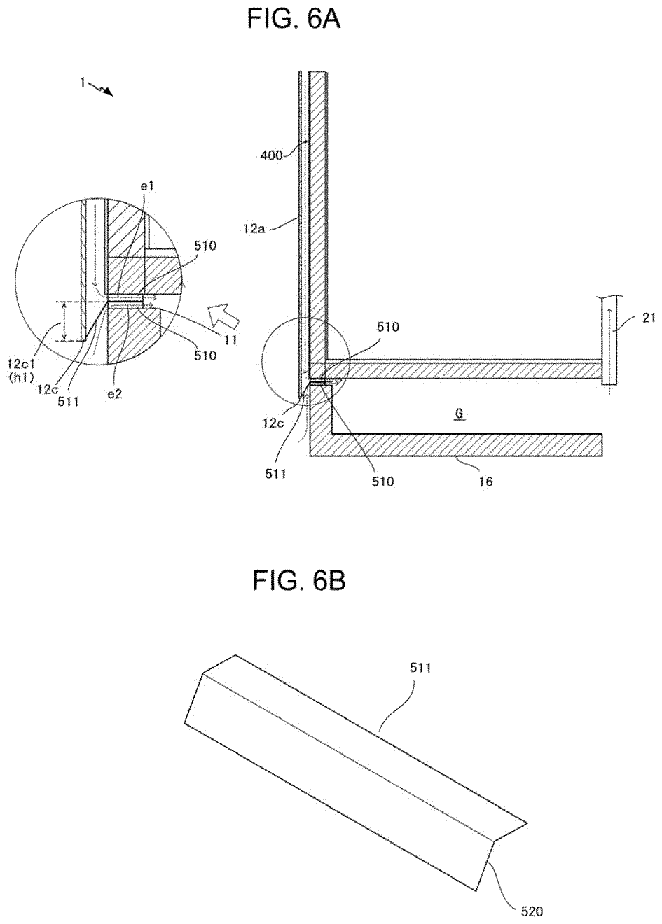

FIGS. 6A and 6B describe the siding system 1 according to a fourth embodiment of the present disclosure. In the fourth embodiment, the overall structure of the building H may be similar to those depicted in the first through third embodiments, except that foundation spacer material 510 and a flashing 511 are provided in the vent 11 of the building H.

Specifically, the flashing 511 may comprise a flexible drip edge formed of metal or plastic material. The flashing 511 may be disposed in a suitable position inside the vent 11, for example, between two layers of foundation spacer material 510, and/or on a single layer of foundation spacer material 510. The flashing 511 is capable of bending under the weight of water such as rainwater collected thereon.

With continued reference to FIGS. 6A and 6B, the flashing 511 may have an inverted V shape in cross section, with a first panel 520 oriented in a generally downward direction upon installation. Although not specifically depicted in the figures, the leading edge of the flashing 511, that is, the free, distal edge of the first panel 520, may be formed in a serrated, saw-toothed configuration.

Where a substantial rainfall results in rainwater accidentally penetrating through the roof 15 into the first ventilation channel 400, the weight of rainwater causes the first panel 520 of the V-shaped flashing 511 to bend further downward, thereby enabling smooth, gravitational drainage without causing rainwater to accumulate in the first ventilation channel 400.

Additionally, the aforementioned serrated configuration at the leading edge of the flashing 511 may facilitate rainwater to flow downward, thereby more effectively preventing accumulation of rainwater inside the first ventilation channel 400, which in turn allows for smooth air flow and effective adjustment of humidity in the rooms and other parts of the building.

The air conditioning method performed with the siding system 1 according to the fourth embodiment is described with reference to FIG. 6A.

Specifically, in the present embodiment, the overall circulation of air in the building H is substantially similar to that depicted in the previous embodiments, except that the pattern of air flow toward the lower end of the first ventilation channel 400 is slightly different from that indicated by dotted arrows f4 in FIG. 1 or the like.

More specifically, as depicted in FIG. 6A, the lower end of the first ventilation channel 400 is closed by the flashing 511 provided in the vent 11. As such, air reaching the flashing 511 is drawn into the underfloor space G while penetrating the respective layers of foundation spacer material 510 above and below the flashing 511. That is, air flowing downward along the first ventilation channel 400 is drawn through the upper layer of foundation spacer material 510 over the flashing 511 to enter the underfloor space G, as indicated by dotted arrow e1. Also, air flowing upward toward the lower end of the first ventilation channel 400 from outside is drawn through the lower layer of foundation spacer material 510 under the flashing 511 to enter the underfloor space G, as indicated by dotted arrow e2.

Accordingly, as the siding system 1 allows the first ventilation channel 400 to be supplied with warm air produced by heating equipment or the like during winter and with cold air produced by cooling equipment or the like during summer, the air flowing through the first ventilation channel 400 may flow into the underfloor space G through the upper layer of foundation spacer material 510 disposed above the flashing 511 at the lower end of the first ventilation channel 400. The incoming air is then mixed with the existing air in the underfloor space G, which is relatively warm in winter and relatively cold in summer, followed by delivery to the ceiling or the ceiling space 301a, then to the louvre 311, or to the air conditioner 200 which subsequently conditions the incoming air to output a conditioned, warm or cold stream of air to other parts of the building H, such as the rooms 300a and 300b in case of the second-story building, or the rooms 300 and 310 in case of the single-story building. Hence, the air circulation throughout the building H provides an air curtain covering the entirety of the building H, leading to further improvement in air-based thermal insulation capability.

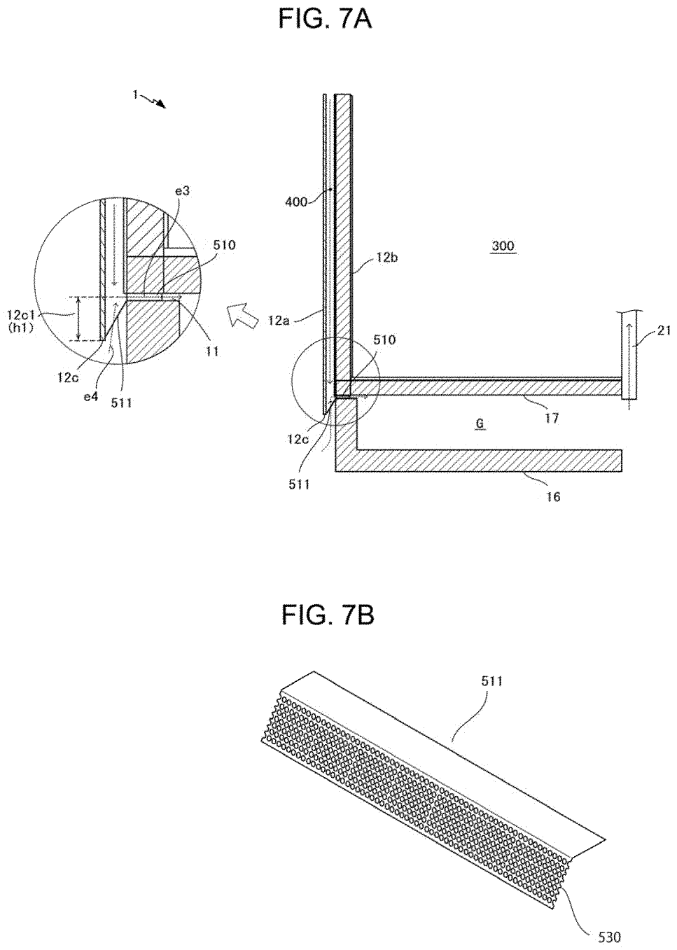

With reference to FIGS. 7A and 7B, in a modification of the fourth embodiment, one or more layers of foundation spacer material consist of only a single layer of foundation spacer material 510 which may be disposed either above or below the flashing 511.

Specifically, as depicted in FIG. 7B, the flashing 511 may have a perforated first panel 530 with multiple holes formed by punching or the like. The perforations in the first panel 530 allow for entry of a limited amount of air as well as discharge of rainwater through the lower end of the first ventilation channel 400, while the flashing 511 serves to guide air from the first ventilation channel 400 into the underfloor space G. Compared to the aforementioned arrangement involving a double layer of foundation spacers, the modification to provide only a single layer of foundation spacer material allows for increased simplicity and reduced production cost of the relevant structure.

The pattern of air flow toward the lower end of the first ventilation channel 400 in the present embodiment, corresponding to that indicated by dotted arrows f4 in FIG. 1, is described as follows.

Specifically, as depicted in FIG. 7A, air flowing downward along the first ventilation channel 400 is drawn through the layer of foundation spacer material 510 over the flashing 511 to enter the underfloor space G, as indicated by dotted arrow e3. Also, air flowing upward toward the lower end of the first ventilation channel 400 from outside passes through the perforations of the first panel 530 of the flashing 511 disposed in the vent 11, as indicated by dotted arrow e4, and is subsequently drawn through the layer of foundation spacer material 510 over the flashing 511 to enter the underfloor space G, as indicated by dotted arrow e3.

It is to be understood that the present invention is not limited to the embodiments described above, and various modifications and alternative embodiments are possible without departing from the scope of the appended claims. Accordingly, the present invention encompasses any and all embodiments derived from any such modifications and combinations of features within the scope of the appended claims.

### LIST OF REFERENCE NUMERALS

1 Convection-enhanced thermal insulation or siding system for air-insulated building
10 Base
11 Vent
12 Exterior wall
12a First peripheral wall
12b Second peripheral wall
12c Lower edge of first peripheral wall
12c1 Extra siding dimension
13 Interior wall
14 Ceiling board
15 Roof
15a Inner lining
15b Ridge cover
16 Foundation
17 Flooring
18 Gap
20 First duct
20a First end of first duct
20b Second end of first duct
21 First duct
21a First end of first duct
21b Second end of first duct
22 Second duct
22a First end of second duct
22b Second end of second duct
23 Third duct
51 First fan
200 Air conditioner
210 Air inlet
300 Room
300a First-floor room
300b Second-floor room
301a Ceiling space
310 Room
311 Louver
320 Opening
400 First ventilation channel
410 Second ventilation channel
420 Ridge ventilation unit
421 Gap
500 Ventilation fan
510 Foundation spacer material
511 Flashing
520 First panel of flashing
530 First panel of flashing
F Attic
G Underfloor space
H Building

1. A convection-enhanced central air conditioning system for a building, the system comprising:
a first duct that has a first end thereof open and disposed in an underfloor space of the building, and a second end thereof open and disposed either on a ceiling of a first floor or in a ceiling space of the building;
a louver disposed on the ceiling of the first floor of the building; and
a vent that opens to the underfloor space,
wherein a lower edge of a first peripheral wall of the building is positioned lower and closer to a foundation of the building than the vent is,
wherein a first ventilation channel is formed between the first peripheral wall and a second peripheral wall that is disposed inside of the first peripheral wall, and
wherein the first ventilation channel has an opening at a lower end thereof.

2. The convection-enhanced central air conditioning system according to claim 1,
wherein the first ventilation channel has an opening at an upper end thereof; and
wherein a second ventilation channel is provided in a roof of the building, the second ventilation channel communicating with the opening at the upper end of the first ventilation channel.

3. The convection-enhanced central air conditioning system according to claim 1,
wherein the system sends air from the underfloor space of the building either to the ceiling of the first floor or into the ceiling space;
wherein the system is capable of heating the air; and
wherein the system is capable of sending the heated air to the first floor of the building via the louver.

4. A convection-enhanced central air conditioning system for a two-story building, the system comprising:
an exterior wall including a first peripheral wall that constitutes an exposed, visible surface of the two-story building, and a second peripheral wall that defines a room within the two-story building;
a first ventilation channel provided in a gap between the first peripheral wall and the second peripheral wall, the first ventilation channel having an opening at a lower end thereof;
a ventilation fan that sends air to the first ventilation channel; and
a vent disposed at a level higher than a lower edge of the first peripheral wall, the vent defining an air passageway through which air flowing downward along a section of the first ventilation channel located in a first floor of the two-story building enters an underfloor space of the two-story building.

5. The convection-enhanced central air conditioning system according to claim 4, further comprising:
a second ventilation channel provided in a roof of the building, the second ventilation channel communicating with an opening at an upper end of the first ventilation channel; and
a ridge ventilation unit provided in a ridge of the building, the ridge ventilation unit communicating with the second ventilation channel.

6. The convection-enhanced central air conditioning system according to claim 4, further comprising:
a first duct that has a first end thereof disposed in the underfloor space, and a second end thereof disposed either on a ceiling or in a ceiling space of the building; and
a first fan that directs air to flow from the first end of the first duct to the second end of the first duct.

7. The convection-enhanced central air conditioning system according to claim 4, wherein the first peripheral wall is formed of siding material.

8. The convection-enhanced central air conditioning system according to claim 4, wherein the vent is positioned higher than the lower edge of the first peripheral wall by 100 mm or more and 200 mm or less.

9. The convection-enhanced central air conditioning system according to claim 4, further comprising:
one or more layers of foundation spacer material provided in the vent; and
a flashing on or between the one or more layers of foundation spacer material.

10. The convection-enhanced central air conditioning system according to claim 9,
wherein the one or more layers of foundation spacer material provided in the vent consist of a single layer of foundation spacer material;
wherein the flashing has a perforated panel directed generally downward; and
wherein the flashing is disposed either above or below the single layer of foundation spacer material.
